(19) United States
(12) Patent Application Publication
(10) Pub. No.: US 2026/0105760 A1
(43) Pub. Date: Apr. 16, 2026

(54) METHOD FOR IDENTIFYING VEHICLE USER AND VEHICLE FOR IMPLEMENTING SAME

(71) Applicants: Hyundai Motor Company, Seoul (KR); Kia Corporation, Seoul (KR)

(72) Inventor: Nam Hyuk Kim, Hwaseong-si (KR)

(21) Appl. No.: 19/331,471

(22) Filed: Sep. 17, 2025

(30) Foreign Application Priority Data
Oct. 10, 2024 (KR) 10-2024-0137634

(51) Int. Cl. G06V 20/59; G01C 21/34; G06N 3/09; G06V 10/74; G06V 10/774; G06V 40/16

(52) U.S. Cl. CPC G06V 20/59; G01C 21/3484; G06N 3/09; G06V 10/761; G06V 10/774; G06V 40/172

(57) ABSTRACT

A method for identifying a user in a vehicle is carried out by a memory that stores instructions and a processor that executes the instructions. The method includes acquiring image data of the user situated in the vehicle; acquiring route data according to a request of the user; generating image-estimated user data estimated on the basis of the image data; generating route-estimated user data estimated on the basis of the route data; and generating user identification information based on the image-estimated user data and the route-estimated user data.

### CROSS-REFERENCE TO RELATED APPLICATION

This application claims under 35 U.S.C. § 119(a) the benefit of Korean Patent Application No. 10-2024-0137634 filed on Oct. 10, 2024, the entire contents of which are incorporated herein by reference.

### BACKGROUND

### (a) Technical Field

The present disclosure relates to a method for identifying a vehicle user and a vehicle for implementing the same, more particularly, to the method for identifying the vehicle user and to the vehicle that utilizes image and route estimation information to identify the vehicle user in order to provide personalized functions and services to the vehicle user.

### (b) Description of the Related Art

Personalization functions and services of vehicles may be provided by collecting driving data for each vehicle and analyzing various usage patterns. That is, existing personalization services are provided by identifying the tendencies of each vehicle, even if the vehicle is used by multiple passengers.

However, it is often the case that a vehicle is actually used by a plurality of users belonging to a specific group, such as a family. Since the driving characteristics are different for different passengers of different ages and genders, it is difficult to estimate the driving characteristics for each individual in the development of the personalization algorithm. Because the tendencies of various passengers are mixed, the personalized service may not accurately reflect the propensity of a particular customer. In addition, in a case where the similar passenger group is constituted by passenger information composed of similar age groups, genders, residences, and the like, it is difficult to further reflect the tendencies of individual passengers.

Since the vehicle usage characteristics of the passenger are not accurately estimated, a general-purpose service that is not a suitable service for the actual passenger is provided, and there is a limit in realizing a high-performance personalization service.

### SUMMARY

The present disclosure is directed to providing a method for identifying a vehicle user and a vehicle that realize accurate identification of the vehicle user, for providing a personalized function and service to the vehicle user.

The technical problems to be solved in the present disclosure are not limited to the above-mentioned technical problems, and other technical problems that are not mentioned will be clearly understood by those skilled in the art in the technical field to which the present disclosure belongs from the following description.

According to the present disclosure, a method for identifying a user of a vehicle includes steps of: providing a memory configured to store at least one instruction and a processor configured to execute the at least one instruction stored in the memory; acquiring, by the processor, image data of the user situated in the vehicle; acquiring, by the processor, route data according to a request of the user; generating, by the processor, image-estimated user data estimated on the basis of the image data; generating, by the processor, route-estimated user data estimated on the basis of the route data; and generating, by the processor, user identification information based on the image-estimated user data and the route-estimated user data.

According to one aspect, there is provided a method for identifying a vehicle user, the method comprising: acquiring image data of a user riding in a vehicle; acquiring route data according to a request of the user; generating image-estimated user data based on the image data; generating route-estimated user data based on the route data; and generating user identification information based on the image-estimated user data and the route-estimated user data.

According to the embodiment of the present disclosure in the method, the image-estimated user data may be generated by an image-based deep learning model, and the image-based deep learning model uses image-based user matching information according to a similarity between image data of a previous user of the vehicle and the image data of the user as the image-estimated user data.

According to the embodiment of the present disclosure in the method, the image-estimated user data may comprise at least one of probability information of the previous user according to the image-based matching information and a user identified by image inference.

According to the embodiment of the present disclosure in the method, the image data of the user may be image data including a face of the user.

According to the embodiment of the present disclosure in the method, the route-estimated user data may be output by a driving trajectory-based deep learning model, and the driving trajectory-based deep learning model may use route-based user matching information based on a similarity between driving data of a previous user of the vehicle and route data of the user as the route-estimated user data.

According to the embodiment of the present disclosure in the method, the route-estimated user data may comprise at least one of probability information of the previous user according to the route-based matching information and a user identified by driving trajectory inference.

According to the embodiment of the present disclosure in the method, the driving data and the route data may comprise a destination, a stopover, a driving trajectory, a travel time zone, and a travel time.

According to the embodiment of the present disclosure in the method, the driving trajectory-based deep learning model may be trained by contrastive learning using driving data previously generated by driving of the plurality of users.

According to the embodiment of the present disclosure in the method, the generating user identification information may comprise generating, by a deep learning-based ensemble model employing the image-estimated user data and the route-estimated user data as inputs, the user identification information.

According to the embodiment of the present disclosure in the method, the method further may comprise outputting setting-estimated user data estimated on the basis of vehicle setting information according to a request of the user, before the generating user identification information. The ensemble model may employ the setting-estimated user data as an additional input to generate the user identification information.

According to another embodiment of the present disclosure, a vehicle for implementing identification of a user includes: a camera configured to obtain images of objects inside the vehicle; a memory configured to store at least one instruction; and a processor configured to execute the at least one instruction stored in the memory, wherein upon execution of the at least one instruction, the processor is configured to: acquire image data of the user situated in the vehicle; acquire route data according to a request of the user; generate image-estimated user data estimated on the basis of the image data; generate route-estimated user data estimated on the basis of the route data; and generate user identification information based on the image-estimated user data and the route-estimated user data.

According to another aspect, there is provided a vehicle for implementing identification of a vehicle user, the vehicle comprising: a camera obtaining images of objects inside a vehicle; a memory storing at least one instruction; and a processor executing the at least one instruction stored in the memory. The processor is configured to: acquire image data of a user riding in the vehicle; acquire route data according to a request of the user; generate image-estimated user data estimated on the basis of the image data; generate route-estimated user data estimated on the basis of the route data; and generate user identification information based on the image-estimated user data and the route-estimated user data.

According to the present disclosure, a non-transitory computer readable medium containing program instructions executed by a processor includes: program instructions that acquire image data of a user situated in a vehicle; program instructions that acquire route data according to a request of the user; program instructions that generate image-estimated user data estimated on the basis of the image data; program instructions that generate route-estimated user data estimated on the basis of the route data; and program instructions that generate user identification information based on the image-estimated user data and the route-estimated user data.

The features briefly summarized above for this disclosure are only exemplary aspects of the detailed description of the disclosure which follow, and are not intended to limit the scope of the disclosure.

The technical problems solved by the present disclosure are not limited to the above technical problems and other technical problems which are not described herein will be clearly understood by a person (hereinafter referred to as an ordinary technician) having ordinary skill in the technical field, to which the present disclosure belongs, from the following description.

### BRIEF DESCRIPTION OF THE DRAWINGS

FIG. 1 is a diagram illustrating that a vehicle communicates with another device to transmit and receive data.

FIG. 2 is a diagram illustrating a module constituting a vehicle according to an embodiment of the present disclosure.

FIG. 3 is a diagram illustrating modules constituting a server according to the present disclosure.

FIG. 4 is a diagram illustrating a user identification model.

FIG. 5 is a diagram illustrating construction and inference of a driving trajectory embedding-based model.

FIG. 6 is a flowchart of a method for identifying a vehicle user according to another embodiment of the present disclosure.

### DETAILED DESCRIPTION OF EXEMPLARY EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, exemplary embodiments of the present disclosure will be described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween.

In the present disclosure, the terms first, second, etc. are only used to distinguish one element from another and do not limit the order or the degree of importance between the elements unless specifically mentioned. Accordingly, a first element in an embodiment could be termed a second element in another embodiment, and, similarly, a second element in an embodiment could be termed a first element in another embodiment, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

The advantages and features of the present disclosure and the way of attaining them will become apparent with reference to embodiments described below in detail in conjunction with the accompanying drawings. Embodiments, however, may be embodied in many different forms and should not be constructed as being limited to example embodiments set forth herein. Rather, these embodiments are provided so that this disclosure will be complete and will fully convey the scope of the disclosure to those skilled in the art.

In the present disclosure, each of phrases such as “A or B”, “at least one of A and B”, “at least one of A or B”, “A, B or C”, “at least one of A, B and C”, “”at Each of the phrases such as “at least one of A, B or C” and “at least one of A, B, C or combination thereof” may include any one or all possible combinations of the items listed together in the corresponding one of the phrases.

In the present disclosure, expressions of location relations used in the present specification such as “upper”, “lower”, “left” and “right” are employed for the convenience of explanation, and in case drawings illustrated in the present specification are inversed, the location relations described in the specification may be inversely understood.

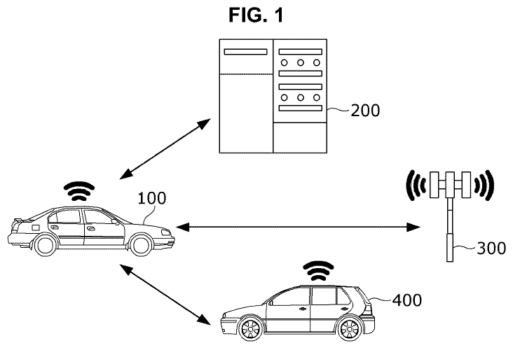

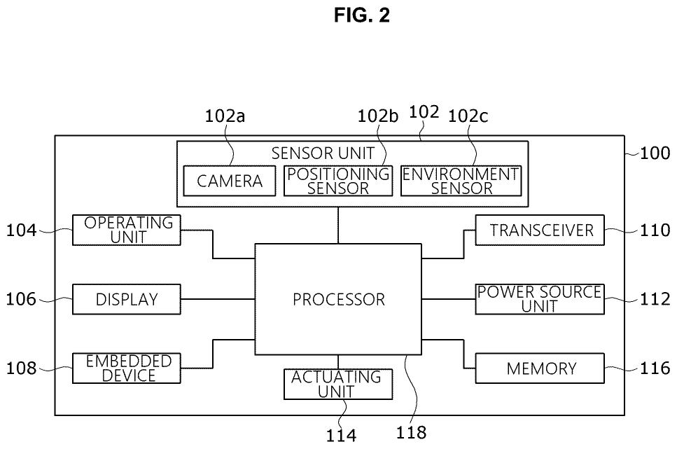

Hereinafter, a method for identifying a vehicle user and a vehicle for implementing the same will be described with reference to FIGS. 1 and 2. FIG. 1 is a diagram illustrating that a vehicle communicates with another device to transmit and receive data.

Referring to FIG. 1, a vehicle 100 may be driven based on electric energy or gas. In the case of the electrical energy, the vehicle 100 may, for example, employ a purely battery-based vehicle driven solely by a high-voltage battery or a gas-based fuel cell as the energy source. Further, the fuel cell may utilize various forms of gas capable of generating electrical energy, and the gas may be filled into the vehicle 100 in a liquefied state, for example. Here, the gas may be hydrogen, for example. However, various gases are applicable without being limited thereto. In the case of fossil energy, the vehicle 100 may be equipped with an internal combustion engine that is driven based on a fuel, such as gasoline, diesel, or liquefied gas, and that drives an actuating unit 114 by combustion of the fuel. As another example, the vehicle 100 may selectively utilize the energy of a fossil energy-based internal combustion engine and an electric battery to drive the actuating unit 114, which may be a hybrid type of vehicle.

The vehicle 100 may refer to a device that may move. The vehicle 100 is a ground vehicle driving on the ground, and may be a conventional passenger or commercial vehicle, a purpose built vehicle (PBV), or the like. The vehicle 100 may be a four-wheeled vehicle, such as a passenger car, an SUV, a small truck, or may be a vehicle with more than four wheels, such as a bus, a large truck, a container carrying vehicle, a heavy-duty vehicle, or the like. The vehicle 100 may be a robot in its broadest sense, such as a moving means, and the robot may be moved using wheels, trajectories, or other moving modules. The vehicle 100 may be controlled and driven through autonomous driving, and the autonomous driving may be implemented as semi-autonomous driving or fully autonomous driving.

Meanwhile, the vehicle 100 may perform communication with another device 200, 300 or another vehicle 400. Other devices may include, for example, a server 200 that supports various controls, state management, and driving of the vehicle 100, an intelligent transportation system (ITS) device 300 for receiving information from the ITS, various types of user devices, and the like. The server 200 is, for example, an external device operated by a vehicle manufacturer or provided to provide various functions and services of the vehicle 100, and may receive connected data of the vehicle 100 and transmit data necessary for a request of the vehicle 100. The server 200 may transmit various information and software modules used for control of the vehicle 100 to the vehicle 100 in response to a request and data transmitted from the vehicle 100 and a user device, so as to support driving and various services of the vehicle 100.

The ITS device 300 is, for example, a roadside base station (road side unit; RSU), and the ITS device 300 may interchange vehicle recognition data, driving control and state data, environmental data around the vehicle, and the like via V2I with the vehicle 100, to assist the user in driving the own vehicle or support autonomous driving of the vehicle 100. The vehicle 100 may interchange the above-listed data via V2V with the other vehicle 400 to support manual driving or autonomous driving.

The vehicle 100 may communicate with other vehicles or other devices based on cellular communication, wireless access in vehicular environment (WAVE) communication, dedicated short range communication (DSRC) or near field communication, or other communication scheme.

For example, the vehicle 100 may use a communication network such as LTE or 5G, a WiFi communication network, a WAVE communication network, or the like as a cellular communication network for communication with the server 200, the ITS device 300, and the other vehicle 400. As another example, a DSRC or the like used in the vehicle 100 may be used for communication between vehicles. A communication manner between the vehicle 100, the server 200, the ITS device 300, the another vehicle 400, and the user device is not limited to the foregoing embodiment.

FIG. 2 is a diagram illustrating a module constituting a vehicle according to an embodiment of the present disclosure.

The vehicle 100 may include a sensor unit 102, an operating unit 104, a display 106, an embedded device 108, and a transceiver 110.

The sensor unit 102 may include various types of detectors for sensing various states and situations occurring in the external environment of the vehicle 100, objects inside the vehicle 100, internal systems, user manipulations, and the ride space. The sensor unit 102 may include an internally-oriented camera 102a that obtains images associated with objects within the vehicle 100. In addition, the sensor unit 102 includes a positioning sensor 102b that confirms the position of the vehicle 100, and the positioning sensor 102a may be, for example, a GPS sensor or a GNSS sensor. The sensor unit 102 may have an environment sensor 102c that recognizes dynamic and static objects present outside the vehicle 100 to obtain behavior of the objects. The environmental sensor 102c may include at least one of an externally-oriented image sensor, a lidar sensor, a radar sensor, and an ultrasonic sensor. The sensor unit 102 may include a wheel sensor, a wheel steering sensor, a posture sensor, and the like to check the longitudinal speed, the lateral behavior, the driving posture, and the like. The sensor unit 102 may further include a sensing module that senses various situations not listed here.

The operating unit 104 may be configured as a module for a user to navigate for driving. For example, the operating unit 104 may be a steering wheel for manual driving, an automatic or manual transmission actuator, an accelerator pedal, a brake pedal, a transmission, or the like. The operating unit 104 may further include an interface for use, release, and selection of detailed functions of the autonomous driving mode requested by the user, so that the user uses the autonomous driving function.

The display 106 may serve as a user interface. The display 106 may indicate to output, by a processor 118, an operating state of the vehicle 100, a control state, route/traffic information, remaining energy information, content requested by the driver, and the like. In addition, the display 106 may be configured as a touch screen capable of detecting driver input, to receive a request from the driver instructing the processor 118.

The embedded device 108 may be a device that is installed in the interior of the vehicle 100 to provide functionality or convenience essential to the use of the vehicle 100. The embedded device 108 is a type of non-driving electric device other than the driving power system such as a wheel driving unit, and may be an auxiliary device supplied with electric power from a power source unit 112. For example, the embedded device 108 includes, but is not limited to, a seat device on which an passenger sits, a navigation device, an indoor communication device, an air conditioning system, a lighting system, a content device that provides video/audio content, an autonomous driving assistance device, and a regenerative braking device.

For ease of use by the user, the embedded device 108 may have a setting component that provides for the user to adjust settings associated with various controls and states of the device described above. The setting component may be configured as a hardware interface or a software interface. The hardware interface may be variously provided, e.g., as buttons, scroll wheels, levers, etc. The software interface may be, for example, a graphical user interface displayed on the touchable display 106, a voice command recognition-based voice interface, or the like. The setting information of the device specified by the user by the setting component may be stored and managed in a memory 116. In addition, the setting information may be managed separately for each user. In the present disclosure, the setting information may be referred to as vehicle setting information.

As an example of a device configuration, the seat device may have a seat setting module that adjusts the seat position for the user's ride comfort. The seat setting module may be configured to adjust a seat position of at least one of all the seats in the room. The sheet setting module may be installed in the vicinity of each sheet, or may be supported by a software interface. The seat position may include at least one of a height of the seat, a position of the seat relative to a vehicle front, a slope of a seat back, a slope of the left seat, a height and a slope of a head rest.

The seat position selected by the user by the seat setting module may be stored as the vehicle setting information by the user's storage request. In addition, a plurality of pieces of vehicle setting information related to the seat position may be managed by a function stored for each user identifier. The user may, for example, select a profile of the user displayed on the display 106 in relation to the identifier, or press a set key/button dedicated to the seat. Accordingly, in a case where a user who has ridden the vehicle 100 does not perform the above-described operation, the setting of the current seat may be maintained. The processor 118 may consider using the vehicle setting information with the current setting, even if there is no setting change. On the other hand, the user may automatically change the setting of the seat to the seat position preset by the user through the operation without any initial complicated operation. When there is a change in the settings described above, the processor 118 may be recognized as utilizing vehicle setting information as a change setting.

The air conditioning system may include a heating device, a cooling device, and a ventilation device. For the setting of the air conditioning system, a user may input air conditioning settings related to the temperature, intensity, and ventilation conditions of the air conditioned system by using an air conditioning panel with buttons, scroll wheel or touchable display 106. As described above, the air conditioning setting is stored in the memory 116 for each user, and may be managed by the vehicle setting information. The operation and manipulation of the air conditioning setting may be described in a manner similar to the seat setting.

The indoor communication device may be, for example, a wired or wireless communication setting for using the application and audio of the user device in the vehicle 100. The user may use an interface provided by the display 106 to input a Bluetooth setting profile and indoor communication settings related to wired and wireless connection options. The indoor communication settings are stored in the memory 116 for each user, as described above, and may be managed with vehicle setting information. The operation and manipulation of the indoor communication setting may be described in a manner similar to the seat setting.

The autonomous driving assistance device may be operated with detailed autonomous options entered by the user. The regenerative braking device may be operated, for example, at a user-requested regenerative brake level. The autonomous option setting and the regenerative braking setting described above may be processed through the corresponding interface, stored in the memory 116 for each user, and managed as vehicle setting information.

The embedded device 108 may include a navigation application (or device) executing on the display 106. In the present disclosure, the navigation application may be abbreviated as navigation. The navigation may receive a route request to the user's destination, transmit the request to the server 200, and receive and provide route data and additional information from the server 200. The route data may be driving data related to a driving trajectory, an expected required time, and traffic information on the route.

The additional information may include, for example, an expected destination of the riding user based on the riding time, a driving trajectory to the expected destination, a plurality of driving trajectories recommended to the destination, service content related to the destination and the stopover, and the like. The driving trajectory is composed of a GPS location trajectory tracked on a map, and the GPS trajectory on the map may be processed into an image form. The stopover may be a point of interest where the user has previously stopped on the intended route, or where the user's preference is estimated based on accumulated driving patterns. The stopover is, for example, but not limited to, a rest area of a highway, a restaurant, a shopping facility, or a cultural facility. The service content may include detailed service details provided by the destination or stopover, expected congestion, operating hours, and the like.

In FIG. 2, the present disclosure mainly describes the embedded device 108 according to the present embodiment. Since the embedded device 108 is a type of load device that consumes energy in addition to the actuating unit 114, the load device may further include various devices in addition to the embedded device 108.

The transceiver 110 may support mutual communication with the server 200, the ITS device 300, the surrounding vehicles 400 and the like. The transceiver 110 may include, for example, a module that processes cellular communication, WAVE, DSRC communication, and the like. The transceiver110 may support communication with an electronic device carried by an passenger inside the vehicle 100.

The vehicle 100 may also include a power source unit 112 and an actuating unit 114.

The power source unit 112 may generate and supply power and electric power to be used for a driving power system and a non-driving power system, such as the actuating unit 114. The non-driving power system may be, for example, the sensor unit 102, the operating unit 104, the display 106, the embedded device 108, the transceiver 110, and the like. When the vehicle 100 is driven on the basis of electrical energy, the power source unit 112 may consist, for example, of an electrical battery which is charged from the outside, or of a combination of an electrical battery and a fuel cell which charges the battery. When the vehicle 100 is driven based on a fossil energy, the power source unit 112 may be configured as an internal combustion engine. Further, when the vehicle 100 is of a hybrid type, the power source unit 112 may be provided by a combination of an internal combustion engine and an electric battery.

The actuating unit 114 includes at least one module that implements a driving operation, and may perform at least one driving operation of a longitudinal control such as acceleration and deceleration and a lateral control such as steering according to a user request from the operating unit 104. To this end, the actuating unit 114 may include a plurality of wheels, a driving force generation module for generating a driving force and providing it to the wheels or transmitting the driving force, a braking module for decelerating driving of the wheels, a steering module for realizing lateral control of the wheels and the like. When the vehicle 100 is driven based on electric energy, the driving force generation module is configured as a motor assembly, and the braking module may further have a regenerative braking function.

The vehicle 100 may also include a memory 116 and a processor 118.

The memory 116 may store applications and various data for control of the vehicle 100 to load applications, read data, or record data at the request of the processor 118. In the present disclosure, the memory 116 may hold a software module that identifies a user in a vehicle. The module may include a deep learning-based user identification model. The memory 116 may also hold task software modules for handling functions or services personalized to the identified user.

In the context of the present disclosure, the memory 116 may store image data of a plurality of users who have previously ridden the vehicle 100, driving data classified for the previous users, and vehicle setting information. The image data is an image recognizable by a living body of the user, and may include, for example, a face of the user. In addition, the image data may have feature information in each user's image for use in the user identification model. The driving data may include, for example, a destination, a stopover, a driving trajectory, a travel time zone, and a travel time. Further, the driving data may have feature information in the driving trajectory of each user for use in the user identification model. The vehicle setting information may have detailed settings and detailed settings-based feature information about the device of the embedded device 108.

The processor 118 may perform overall control of the vehicle 100. The processor 118 may be configured to execute applications and instructions stored in the memory 116. The processor 118 may execute an application that identifies the vehicle user to process the user's request.

In the context of the present disclosure, the processor 118 may execute the user identification model in response to the ride of the at least one user. The processor 118 may perform a process of acquiring image data of a user riding in the vehicle 100 by using the camera 102a and acquiring route data according to a request of the user. The processor 118 may execute a process of generating image-estimated user data based on the image data and generating route-estimated user data based upon the route data. Further, the processor 118 may implement a process of generating user identification information based on at least the image-estimated user data and the route-estimated user data. In addition, when the vehicle setting information of the previous user is stored in the memory 116, the processor 118 may generate setting-estimated user data based on the vehicle setting information, and further use the generated data for processing the user identification information.

Here, the image-estimated user data may be a user identified based on the image data of the user and the image data of a previous user. Further, the image-estimated user data may include various ancillary data used for user identification. For example, the image-estimated user data may have probability information used to identify the user. The probability information may include matching information generated for a plurality of previous user classes based on the image data of the riding user and the previous user. For example, the matching information may be probability vector data per user class.

The route-estimated user data may be the user identified based on the user's route data and from the previous user's driving data. The route data may be a driving trajectory that the user requests for a driving trajectory to a destination using navigation, or that is estimated from the driving of the riding user. The driving data may be grouped and managed for each previous user. Further, the route-estimated user data may include various ancillary data used for user identification. For example, the route-estimated user data may have probability information used to identify the user. The probability information may include matching information generated for a plurality of previous user classes based on the route data and the driving data. For example, the matching information may be probability vector data per user class.

The setting-estimated user data may include a user identified based on vehicle settings information of the riding user and the previous user and ancillary data utilized for the identification. For example, the setting-estimated user data may have probability information used for identification of the user, similar to other estimated user data. The probability information may include matching information generated for a plurality of previous user classes based on the vehicle setting information of the riding user and the previous user. For example, the matching information may be probability vector data per user class.

The processor 118 may handle functions or services that are personalized to the identified user, with the assistance of the task software module and the server 200. For example, the processor 118 may receive a route request input by a user of the vehicle 100, transmit the route request to the server 200, and provide a response to the user processing the request from the server 200. The response may be communicated to the identified user to include customized route data and additional information.

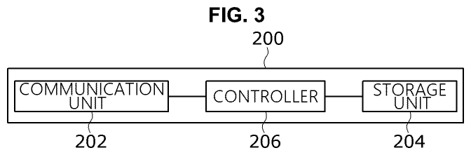

FIG. 3 is a diagram illustrating modules constituting a server according to the present disclosure.

The server 200 may process various service functions that are personalized to the riding user in response to requests of the vehicle 100, as described above. Further, the server 200 may train and distribute the user identification model to the vehicle 100, as an example. In another example, the server 200 may have a trained user identification model built-in and transmit information of a riding user identified in the vehicle 100 to the vehicle 100 by receiving identification-related data received from the vehicle 100. In the present disclosure, for convenience of description, it is described that the vehicle 100 is equipped with a user identification model trained from the server 200. However, the embodiments of the present disclosure may be applied to other examples without technical contradiction.

The server 200 may include a communication unit 202, a storage unit 204, and a controller 206.

The communication unit 202 may transmit and receive data to and from an external device, support mutual communication with the vehicle 100 in the present disclosure, and exchange data with the vehicle 100.

The storage unit 204 stores an application for operating the server 200 and various data, and may load the application or read and record data at the request of the controller 206. In the present disclosure, the storage unit 204 may hold a software module, for example, a navigation application, for processing a route request received from the vehicle 100. The storage 204 may manage map information for processing route requests, driving data of vehicles, demand data for congestion estimation, spot information related to point of interest, and supplemental information for listing and recommendation of multiple interests.

The controller 206 may perform overall control of the server 200. The server 200 may be configured to execute applications and instructions stored in the storage 204. The controller 206 may execute a navigation application to process and respond to the user's request sent from the vehicle 100.

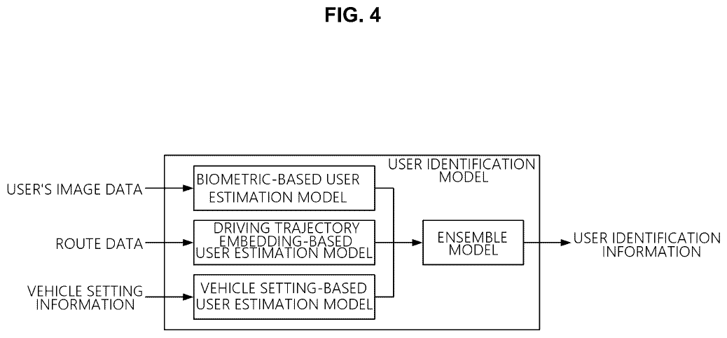

In connection with the present disclosure, the processor 118 may train a user identification model. FIG. 4 is a diagram illustrating a user identification model. The user identification model may be constructed to include an image-based deep learning model, a driving trajectory-based deep learning model, and a deep learning model based on vehicle setting information. Further, the user identification model may be constructed with an ensemble model that combines the output data of the models to generate the final user identification information. In the present disclosure, when the vehicle setting information is not collected from each vehicle 100, the deep learning model based on vehicle setting information may not be constructed.

The image-based deep learning model may be illustrated in FIG. 4 as a biometric-based user estimation model. The biometric-based user estimation model may be trained by using the image data of the user and the identification information of each user collected from each vehicle 100 as input learning data and output learning data, respectively. Here, the image data may be illustrated as including a face.

The biometric-based user estimation model may use a convolutional neural network (CNN) algorithm. The user estimation model may utilize, for example, a You Only Look Once (YOLO) series model. The controller 206 may train the model to cluster image data associated with faces of a plurality of previous users to generate facial recognition-based latent features, and to define user classes for a number of the plurality of users. In addition, the biometric-based user estimation model may train the model to output image-based user matching information according to a similarity between image data of a previous user of the vehicle 100 and image data of a riding user as image-estimated user data. The image-estimated user data may be at least one of probability information of a user according to image-based matching information and a user identified by image inference. The probability information may include, for example, probability vector data per user.

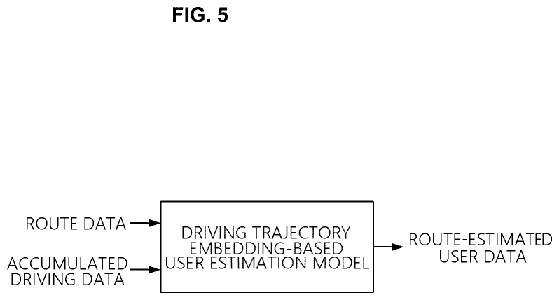

The driving trajectory-based deep learning model may be illustrated in FIG. 4 as a driving trajectory embedding-based user estimation model. FIG. 5 is a diagram illustrating construction and inference of a driving trajectory embedding-based model.

The driving trajectory-based user estimation model may be trained by using the driving data of the previous user and the identification information of each user that are cumulatively collected from each vehicle 100 as input learning data and output learning data, respectively. Here, the driving data may include a destination, a stopover, a driving trajectory, a travel time zone, a travel time, and whether or not the vehicle travels along a navigation route.

The driving trajectory-based user estimation model may use a CNN or a recurrent neural network (RNN) algorithm. The controller 206 may train the model to embed driving data including at least one of a driving trajectory, a destination, a stopover, an interest, and a time zone to output a potential feature, and to assign a user class to driving data having a similar feature. The user class may be assigned as many as the number of previous users of the vehicle 100. In addition, the controller 206 may distinguish between the feature extractable driving trajectory and the non-extractable driving trajectory, and select the driving trajectory that may be specified by the user from among the feature extracted driving trajectories. The controller 206 may construct the model to output route-estimated user data based on the selected driving trajectory. In addition to outputting user identification information, the controller 206 may list a plurality of pieces of information relating to each user's previous driving. For example, a list may be generated to list details pertaining to each user's time zone driving data. This list may be utilized to generate additional information responsive to the user's route request.

The driving trajectory-based user estimation model may train the model to output route-based user matching information based on a similarity between driving data of a previous user and route data of a riding user as route-estimated user data. The route-estimated user data may be at least one of probability information of a previous user according to route-based matching information and a user identified by driving trajectory inference. The probability information may include, for example, per-user probability vector data.

In addition, the driving trajectory-based deep learning model may be trained by contrastive learning using driving data generated in advance by driving of a plurality of users. For example, the controller 206 may train the model to increase the probability of a similar pair of driving data and decrease the probability of a dissimilar pair of driving data according to a predetermined criterion. In this way, the model may output a probability vector for each user with high accuracy.

The deep learning model based on vehicle setting information may be illustrated in FIG. 4 as a vehicle setting-based user estimation model.

When collected from the vehicle 100 of each of the vehicle settings of the plurality of users, the vehicle setting-based user estimation model may be trained by using the vehicle setting information of the previous user and the identification information of each user as input learning data and output learning data, respectively. Since the vehicle setting information is easily generated due to the user's profile selection, the vehicle setting information may be collected as assistance data that may identify the riding user.

The vehicle settings-based user estimation model may use a CNN or RNN algorithm, as an example. As another example, in addition to the deep learning model, the model may be established based on a table that mutually matches a user with a setting according to a user request. In the present disclosure, the model is exemplified as using a deep learning model.

The vehicle settings-based user estimation model may be trained by the controller 206 in a manner similar to other user estimation models. Accordingly, the vehicle-setting-based user estimation model may output setting-based user matching information based on a similarity between vehicle setting information of a previous user and vehicle setting information of an riding user as setting-estimated user data. The setting-estimated user data may be at least one of probability information of a previous user according to the matching information based on the vehicle setting information and a user identified by use of the vehicle setting information. The probability information may include, for example, probability vector data per user. In addition, the setting-estimated user data (e.g., classes for a plurality of users) may be matched with the output results of the biometric-based user estimation model and the driving trajectory embedding-based user estimation models. Accordingly, the reliability of the user identification model may be improved.

The controller 206 may train the ensemble model to combine the data output from each user estimation model, i.e., the image-estimated user data, the route-estimated user data, and the setting estimation data, to generate the final user identification information. The ensemble model may be constructed, for example, as an algorithm based on a weighted analysis of the output data of each model or a majority vote algorithm or the like. The weighted analysis-based algorithm may identify a user as a riding user, e.g., determined by applying parameters (e.g., weighted parameters) learned in the ensemble model to the user or user-specific probability vector data inferred from the respective user estimation data. The majority vote algorithm may identify a user as a riding user by applying a majority vote to the user or probability information inferred from each user estimation data. Even if setting user estimation data is output as a high probability vector for a particular user, the ensemble model may output other users to the riding user, with other user estimation data and parameters having high probability vectors for other users.

The server 200 may use the loss function of each model shown in FIG. 4 to individually train the learnable parameters of the model. As another example, the server 200 may use a loss function applied to the entire user identification model to integrally train parameters of the model.

The controller 206 is illustrated in the present disclosure as consisting of a single processing module. In another example, the controller 206 may be distributed to a plurality of processing modules, and the processing described above may be executed by a distributed processing model.

Hereinafter, the vehicle 100 will be described in detail with reference to FIGS. 1 to 6 regarding user identification processing and subsequent task processing using a user identification model distributed from the server 200.

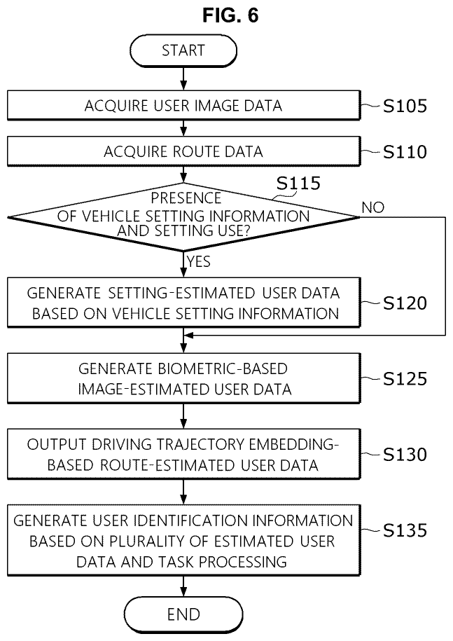

FIG. 6 is a flowchart of a method for identifying a vehicle user according to another embodiment of the present disclosure. Hereinafter, for convenience of description, the vehicle setting information is exemplified by the seat setting information related to the setting of the seat position, but the other vehicle setting information mentioned above may also be utilized as a matter to be described later. In addition, although the process of FIG. 6 is mainly performed by the processor 118, for ease of description, the processor 118 and the vehicle 100 may be described in combination.

First, the processor 118 of the vehicle 100 may activate the camera 102a in response to the riding and the start-on of the at least one user, to acquire image data of the riding user (S105). Here, the image data may be acquired to include a face of the user.

Next, the processor 118 of the vehicle 100 may generate route data in response to receiving route request of the user received by the navigation application (S110). The route request may be a destination desired by the user, a stopover, a keyword of interest that is not a specific destination, or the like. The keyword of interest may be a text/voice message including the driving intention of the user. For example, the keyword of interest may be a nearby restaurant, a movie theater, a shopping center, a rest area during driving, or the like. The route data may be generated to include, for example, a destination, a stopover, a driving trajectory, a driving time zone, and a driving time. In another example, even without a direct request by navigation, the route request may be triggered based on the intended route that is presumed to be the riding user's driving.

Next, the processor 118 may check whether the vehicle setting information of the embedded device 108 exists and determine whether the riding user uses the vehicle setting information (S115). For example, the processor 118 may determine that the riding user is to use the vehicle setting information when the riding user selects his or her profile to change the seat setting information, or when the riding user detects that he or she is to use an existing seat position according to the information without changing the seat setting information.

When there is presence and use of the vehicle setting information, the processor 118 may generate setting-estimated user data using a vehicle setting-based user estimation model that employs the vehicle setting information as input (S120). The model and the estimated user data are described in detail in FIGS. 3-5.

When the vehicle setting information is not present, or when there is no use of the vehicle setting information, the processor 118 may omit generating the setting-estimated user data. The non-use of the vehicle setting information may include, for example, the riding user entering vehicle setting information that exceeds a similar range to previously stored vehicle setting information, or initializing the vehicle setting information. Hereinafter, for convenience of description, an example in which setting-estimated user data is generated will be mainly described. When the data is not generated, the processor 118 may generate user identification information associated with the riding user using an ensemble model that employs as input other estimated user data other than the setting-estimated user data.

Next, the processor 118 may generate image-estimated user data using a biometric-based user estimation model that employs the image data of the riding user and the image data of a previous user as inputs (S125).

The biometric-based user estimation model may use image-based user matching information according to a similarity between image data of a previous user and image data of a riding user as image-estimated user data. Specifically, the image-estimated user data may include at least one of probability information of a previous user according to image-based matching information and a user identified by image inference. Details thereof are described in detail in FIGS. 3 to 5.

The processor 118 may then generate route-estimated user data using a driving trajectory embedding-based user estimation model that employs as inputs route data of the riding user and driving data of the previous user (S130).

The driving trajectory embedding-based user estimation model may use route-based user matching information according to the similarity between the driving data and the route data as the route-estimated user data. Similar to the route data, the driving data may include a destination, a stopover, a driving trajectory, a travel time zone, travel time, route travel according to navigation, and the like. The route-estimated user data may include at least one of probability information of a previous user according to route-based matching information and a user identified by driving trajectory inference. Details thereof are described in detail in FIGS. 3 to 5.

Next, the processor 118 may use the ensemble model to generate user identification information based on the image-estimated user data, the route-estimated user data, and the setting-estimated user data and personalize and process a task of providing the user identification information to the identified riding user (S135).

The user identification information may include, for example, an identifier or class of the riding user. When data of a plurality of riding users is acquired in steps S105 to S115, user identification information may be output for each user. The task may be, for example, a driving trajectory to a destination, an interest recommendation on a route, collection of detailed driving data and a driving pattern of a riding user, or the like. Specifically, based on the list including a plurality of information relating to previous driving of the riding user and similar users, the recommendation/presentation of driving trajectories and interests may be processed to be personalized. Detailed driving data or driving patterns specific to the passenger may also be utilized for other personalization services of the vehicle.

According to the present disclosure, it is possible to provide a method for identifying a vehicle user and a vehicle that realizes accurate identification of the user, to provide personalized functions and services to vehicle users.

In addition, by accurately identifying a user, driving data accumulated by vehicle operation may be accurately analyzed for each user, so that driving tendency for each user may be easily identified.

In addition, by accurately identifying a user, the user's desired destination, route preference, and point of interest may be more accurately predicted and recommended.

Effects that may be obtained in the present disclosure are not limited to the above-mentioned effects, and other effects that are not mentioned will be clearly understood by those skilled in the art in the technical field to which the present disclosure belongs from the following description.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

What is claimed is:

1. A method for identifying a user of a vehicle, the method comprising:
providing a memory configured to store at least one instruction and a processor configured to execute the at least one instruction stored in the memory;
acquiring, by the processor, image data of the user situated in the vehicle;
acquiring, by the processor, route data according to a request of the user;
generating, by the processor, image-estimated user data estimated on the basis of the image data;
generating, by the processor, route-estimated user data estimated on the basis of the route data; and
generating, by the processor, user identification information based on the image-estimated user data and the route-estimated user data.

2. The method of claim 1, wherein the image-estimated user data is generated by an image-based deep learning model, and the image-based deep learning model uses image-based user matching information according to a similarity between image data of a previous user of the vehicle and the image data of the user as the image-estimated user data.

3. The method of claim 2, wherein the image-estimated user data comprises at least one of probability information of the previous user according to the image-based matching information and a user identified by image inference.

4. The method of claim 1, wherein the image data of the user includes a face of the user.

5. The method of claim 1, wherein the route-estimated user data is output by a driving trajectory-based deep learning model, and the driving trajectory-based deep learning model uses route-based user matching information based on a similarity between driving data of a previous user of the vehicle and route data of the user as the route-estimated user data.

6. The method of claim 5, wherein the route-estimated user data comprises at least one of probability information of the previous user according to the route-based matching information and a user identified by driving trajectory inference.

7. The method of claim 5, wherein the driving data and the route data comprise a destination, a stopover, a driving trajectory, a travel time zone, and a travel time.

8. The method of claim 5, wherein the driving trajectory-based deep learning model is trained by contrastive learning using driving data previously generated by driving of the plurality of users.

9. The method of claim 1, wherein the generating user identification information comprises generating, by a deep learning-based ensemble model employing the image-estimated user data and the route-estimated user data as inputs, the user identification information.

10. The method of claim 9, further comprising:
outputting setting-estimated user data estimated on the basis of vehicle setting information according to a request of the user, before the generating user identification information;
wherein the ensemble model employs the setting-estimated user data as an additional input to generate the user identification information.

11. A vehicle for implementing identification of a user, the vehicle comprising:
a camera configured to obtain images of objects inside the vehicle;
a memory configured to store at least one instruction; and
a processor configured to execute the at least one instruction stored in the memory, wherein upon execution of the at least one instruction, the processor is configured to:
acquire image data of the user situated in the vehicle;
acquire route data according to a request of the user;
generate image-estimated user data estimated on the basis of the image data;
generate route-estimated user data estimated on the basis of the route data; and
generate user identification information based on the image-estimated user data and the route-estimated user data.

12. The vehicle of claim 11, wherein the image-estimated user data is generated by an image-based deep learning model, and the image-based deep learning model uses image-based user matching information according to a similarity between image data of a previous user of the vehicle and the image data of the user as the image-estimated user data.

13. The vehicle of claim 12, wherein the image-estimated user data comprises at least one of probability information of the previous user according to the image-based matching information and a user identified by image inference.

14. The vehicle of claim 11, wherein the image data of the user is image data including a face of the user.

15. The vehicle of claim 11, wherein the route-estimated user data is output by a driving trajectory-based deep learning model, and the driving trajectory-based deep learning model uses route-based user matching information based on a similarity between driving data of a previous user of the vehicle and route data of the user as the route-estimated user data.

16. The vehicle of claim 15, wherein the route-estimated user data comprises at least one of probability information of the previous user according to the route-based matching information and a user identified by driving trajectory inference.

17. The vehicle of claim 15, wherein the driving data and the route data comprise a destination, a stopover, a driving trajectory, a travel time zone, and a travel time.

18. The vehicle of claim 15, wherein the driving trajectory-based deep learning model is trained by contrastive learning using driving data previously generated by driving of the plurality of users.

19. The vehicle of claim 11, wherein:
the generation of the user identification information comprises generating, by a deep learning-based ensemble model employing the image-estimated user data and the route-estimated user data as inputs, the user identification information;
the processor is further configured to output setting-estimated user data estimated on the basis of vehicle setting information according to a request of the user, before the generation of the user identification information; and
the ensemble model employs the setting-estimated user data as an additional input to generate the user identification information.

20. A non-transitory computer readable medium containing program instructions executed by a processor, the computer readable medium comprising:
program instructions that acquire image data of a user situated in a vehicle;
program instructions that acquire route data according to a request of the user;
program instructions that generate image-estimated user data estimated on the basis of the image data;
program instructions that generate route-estimated user data estimated on the basis of the route data; and
program instructions that generate user identification information based on the image-estimated user data and the route-estimated user data.
